(19) United States
(12) Patent Application Publication
(10) Pub. No.: US 2026/0320032 A1
(43) Pub. Date: Oct. 15, 2026

(54) HIERARCHICAL DISAMBIGUATION OF INPUT QUERIES

(71) Applicant: GDM Holding LLC, Mountain View, CA (US)

(72) Inventors: Lei Shi, Sunnyvale, CA (US); Pei-yu Chi, Menlo Park, CA (US); Jiaju Ma, Stanford, CA (US)

(21) Appl. No.: 19/174,826

(22) Filed: Apr. 9, 2025

(51) Int. Cl. G06F 16/242; G06F 16/22; G06F 16/248

(52) U.S. Cl. CPC G06F 16/242; G06F 16/2246; G06F 16/248

(57) ABSTRACT

Methods, systems, and apparatus, including computer programs encoded on a computer storage medium, for receiving an input query; generating, from the input query and using a generative neural network, a set of ambiguous facets of the input query; generating tree data representing a hierarchical tree, wherein the hierarchical tree includes a respective set of nodes at each of a plurality of tree levels, wherein each tree level corresponds to a respective one of the ambiguous facets and each node at the tree level represents a candidate value for the corresponding ambiguous facet; identifying a disambiguated input query using the tree data, comprising generating a path from a root node in the hierarchical tree to a leaf node of the tree; generating a response to the disambiguated input query; and providing the response for presentation to the user.

### BACKGROUND

This specification relates to processing data using machine learning models.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that disambiguates an input query using a hierarchical process that is guided by a generative neural network.

According to a first aspect there is provided a method performed by one or more computers, the method comprising: receiving an input query; generating, from the input query and using a generative neural network, a set of ambiguous facets of the input query; generating tree data representing a hierarchical tree, wherein the hierarchical tree includes a respective set of nodes at each of a plurality of tree levels, wherein each tree level corresponds to a respective one of the ambiguous facets and each node at the tree level represents a candidate value for the corresponding ambiguous facet; identifying a disambiguated input query using the tree data, comprising generating a path from a root node in the hierarchical tree to a leaf node of the tree, wherein the path includes a respective node at at least a subset of the plurality of tree levels, wherein the disambiguated input query specifies the respective candidate values represented by the nodes included in the path, and wherein generating the path comprises, for each of the at least a subset of the plurality of tree levels: providing, for presentation to the user, data specifying the candidate values for the ambiguous facet corresponding to the current tree level; in response, receiving data representing a user input specifying a value of the ambiguous facet corresponding to the current tree level; and adding, to the path, a node representing the specified value; generating a response to the disambiguated input query; and providing the response for presentation to the user.

In some implementations, receiving a user input specifying a value of the ambiguous facet corresponding to the tree level comprises receiving a user input selecting one of the candidate values of the ambiguous facet corresponding to the tree level; and adding, to the path, a node representing the specified value comprises adding the node representing the selected candidate value.

In some implementations, receiving a user input specifying a value of the ambiguous facet corresponding to the tree level comprises receiving a user input specifying a new value for the ambiguous facet; the method further comprises: updating the tree data to include data representing a new node at the tree level that represents the new value for the ambiguous facet; and adding, to the path, a node representing the specified value comprises adding the new node representing the new value.

In some implementations, updating the tree data to include data representing a new node at the tree level that represents the new value for the ambiguous facet comprises updating the tree data to include one or more child nodes of the new node.

In some implementations, generating, from the input query and using a generative neural network, a set of ambiguous facets of the input query comprises: obtaining search results for the input query from a search engine; generating an input to the generative neural network that comprises contents from the search results and the input query; and processing the input using the generative neural network to generate an output that specifies the set of ambiguous facets.

In some implementations, the input to the generative neural network further comprises data specifying a taxonomy of ambiguous facet types.

In some implementations, the output of the generative neural network further identifies, for each ambiguous facet, an ambiguous facet type for the ambiguous facet.

In some implementations, generating the tree data representing the hierarchical tree comprises, for each tree level and for each node in a preceding tree level: generating an input from the input query and respective candidate values of ambiguous facets represented by the node in the preceding tree level and any parent nodes of the node in the preceding tree level; and processing the input using the generative neural network to generate an output specifying candidate values for the ambiguous facet corresponding to the tree level given that the ambiguous facets corresponding the preceding tree level and any parent nodes of the node in the preceding tree level have the candidate values represented by the node in the preceding tree level and any parent nodes of the node; and generating a respective child node for the node in the preceding tree level representing one or more of the candidate values for the ambiguous facet corresponding to the tree level.

In some implementations, for each of one or more particular tree levels of the tree levels, the tree data representing the hierarchical tree for at least a next particular tree level in the tree is generated in parallel with identifying the node in the path at the particular tree level.

In some implementations, for each next particular tree level, processing the input using the generative neural network to generate an output specifying candidate values for the ambiguous facet corresponding to the next particular tree level is performed in parallel with identifying the node in the path at the particular tree level.

In some implementations, each leaf node of the hierarchical tree corresponds to a respective candidate disambiguated input query; generating the tree data further comprises, for each leaf node: generating a response to the respective candidate disambiguated input query corresponding to the leaf node; and storing the response in association with the leaf node; and generating the response to the respective input query comprises: retrieving, from the tree data, the response associated with the leaf node in the path.

In some implementations, generating the response to the respective candidate disambiguated input query corresponding to the leaf node comprises processing the respective candidate disambiguated input query using an answer generation system, the answer generation subsystem using a search engine to perform a search using the respective candidate disambiguated input query to obtain the response; and further comprising: in parallel with identifying the nodes in the path at one or more of the particular tree levels: i) generating the tree data representing the hierarchical tree for each next particular tree level until reaching one of the leaf nodes, and then ii) performing the search using the respective candidate disambiguated input query corresponding to the leaf node.

In some implementations, generating the tree data further comprises: determining that a particular leaf node corresponds to an invalid candidate disambiguated input query; in response: iteratively pruning the tree until the particular leaf node and all parent nodes of the particular leaf node that do not have other child nodes are removed from the tree.

In some implementations, generating a response to the disambiguated input query comprises: generating a plurality of responses to the disambiguated query that each provide a different amount of information relating to the disambiguated query.

In some implementations, generating a response to the disambiguated input query further comprises obtaining an image by querying an image search engine.

In some implementations, the method further comprises: after identifying the disambiguated input query using the tree data, receiving a user input identifying a particular node in the tree; and traversing the tree starting from the particular node to identify another disambiguated input query.

In some implementations, the input query comprises a request for diagnosing a fault in a mechanical, electronic, or computing system and includes fault log data that has been captured from the mechanical, electronic, or computing system that characterizes the fault; the set of ambiguous facets of the input query relate to aspects of the fault that can have multiple possible values; and the response identifies a cause of the fault.

In some implementations, the method further comprises using the identified cause of the fault to repair the fault.

According to another aspect there is provided a method performed by one or more computers, the method comprising: receiving an input query from a user; obtaining data specifying a disambiguated input query from the input query, comprising: for each of at least a subset of a plurality of tree levels that each correspond to a respective one of a set of ambiguous facets of the input query and that each have one or more nodes that represent a candidate value for the corresponding ambiguous facet: presenting to the user data specifying the candidate values for the ambiguous facet corresponding to the tree level; in response, obtaining a user input specifying a value of the ambiguous facet corresponding to the tree level; and indicating, in the disambiguated input query, that the ambiguous facet corresponding to the tree level has the specified value; obtaining a response to the disambiguated input query; and providing the response for presentation to the user.

Other aspects include systems and non-transitory computer storage media that store instructions that when executed by one or more computers cause the one or more computers to perform the method as described above.

Particular embodiments of the subject matter described in this specification can be implemented so as to realize one or more of the following advantages.

User text prompts provided as input to a search engine or to a dialogue agent are often brief or incomplete, either due to the inherent ambiguity of language, a lack of domain knowledge, or simply out of convenience.

Such user text prompts may lead to multiple possible answers in response. Existing solutions commonly answer ambiguous questions without explicitly supporting both answer finding and knowledge exploration. For example, existing solutions May 1) make assumptions about the ambiguities, 2) generate a long-form catch-all answer, or 3) ask a series of clarification questions. However, the first approach may be prone to introducing unintended biases. The second approach may produce long text that could be difficult to read and digest. The third approach asks clarification questions and provides suggestive options, which require users to have domain knowledge of each option.

The system described in this specification can, upon receiving an input query from a user, generate a set of ambiguous facets to build a hierarchical tree that does not simply minimize the number of disambiguation turns. In implementations data specifying a taxonomy of ambiguous facet types, which can be supplied in addition to search results for the input query from a search engine, facilitate generating an input for a generative neural network to produce the set of ambiguous facets. By building the hierarchical tree from the generated set of ambiguous facets, the system can indicate the number of clarifying questions that the system needs to ask to disambiguate the input query.

The system can further provide suggestive options alongside each clarifying question, requiring less pre-existing knowledge from a user needs to answer the clarifying questions on the topic of the input query. In this way the system can provide objective assistance to the user, by not relying on user knowledge. In implementations the provided suggestive options can also allow the user to backtrack and explore other answers in the ambiguity space. Moreover, the system can allow the user to add alternatives to the suggestive options provided, supporting expansion of the disambiguation options provided by the system.

Some implementations of the system can take advantage of the time taken by user interactions to perform lookahead processing to obtain information for resolving future ambiguities. For example, in some implementations whilst the user is providing user input to resolve an ambiguity at a particular level of the tree the system can build one or more next tree levels, and optionally perform a search when a leaf node is reached. Building a tree level can involve multiple calls to the generative neural network, which can take time, and querying a search engine, e.g., for an Internet search, also has some latency. By using the “waiting” time of a user to perform lookahead processing, the user can be given an experience of a low latency system, even where additional processing is used.

Some implementations of the system can be used for fault identification and repair of mechanical systems, electronic systems, and computing systems, as described further later.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example dialog system.

FIG. 2 shows an example hierarchical tree.

FIGS. 3A and 3B show an example graphical user interface for the disambiguation process and the corresponding hierarchical tree generated.

FIG. 4 is a flow diagram of an example process for generating a response to an input query.

FIG. 5 is a flow diagram of an example process for generating a set of ambiguous facets of an input query.

FIG. 6 is a block diagram of an example ambiguous facet generation system.

FIG. 7 is a flow diagram of an example process for generating tree data representing a hierarchical tree.

FIG. 8 shows a hierarchical tree before and after expansion from a user input of an alternative value to the candidate values provided in the example graphical user interface.

Like reference numbers and designations in the various drawings indicate like elements.

### DETAILED DESCRIPTION

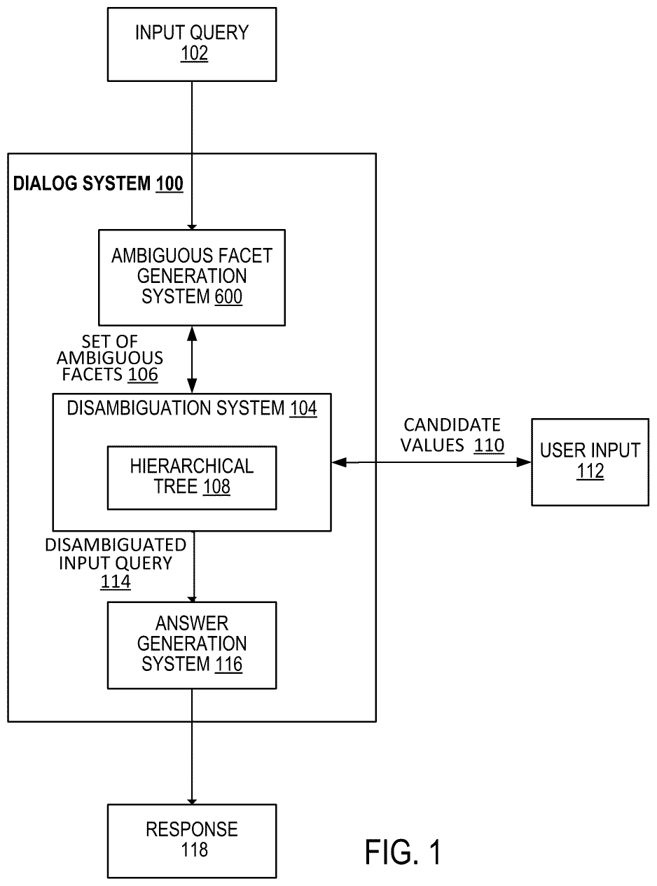

FIG. 1 shows an example dialog system 100. The dialog system 100 is an example of a system implemented as computer programs on one or more computers in one or more locations in which the systems, components, and techniques described below are implemented.

The dialog system 100 receives queries from users and provides responses. Queries from users can sometimes be ambiguous such that the dialog system 100 cannot determine an appropriate response without disambiguating the query.

The dialog system 100 includes an ambiguous facet generation system 600, a disambiguation system 104, and an answer generation system 116.

Through the dialog system 100, the ambiguous facet generation system 600 receives an input query 102 from a user.

The ambiguous facet generation system 600 generates a set of ambiguous facets 106 from the input query 102 using a generative neural network. Examples of generative neural network architectures will be described below. A facet is a specific aspect or attribute of the input query 102. An ambiguous facet is one that can have multiple possible values. That is, the input query 102 lacks the context necessary to resolve the facet to a single value.

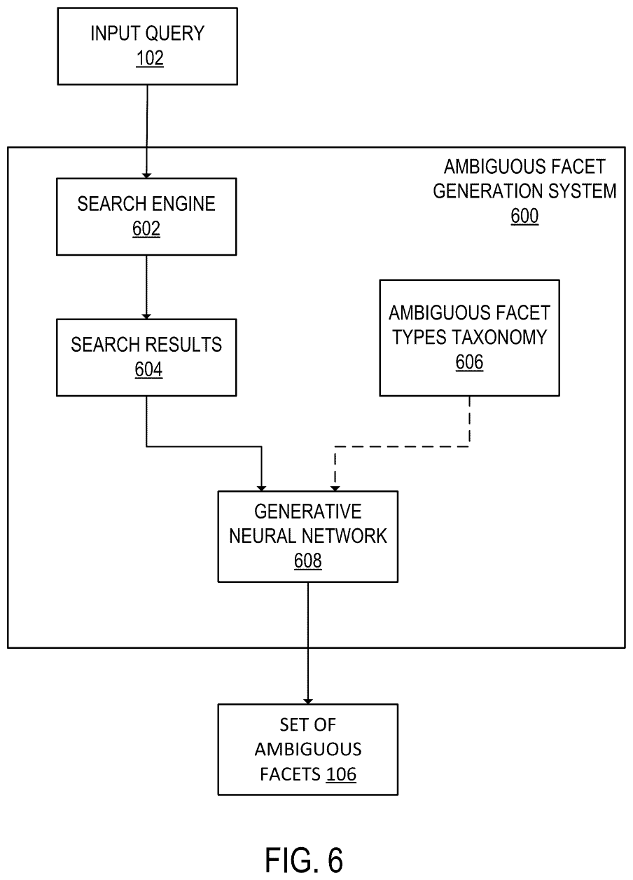

The ambiguous facet generation system 600 is described in more detail below with reference to FIG. 6.

The input query can be a query for any appropriate machine learning task.

The machine learning tasks can include any machine learning task that (i) operates on a network input that is an input sequence, (ii) generates a network output that is an output sequence, or (iii) both.

Some examples of machine learning tasks that the neural network can be configured through training to perform are discussed below.

As one example, the task may be a neural machine translation task. For example, if the input to the neural network is a sequence of text, e.g., a sequence of words, phrases, characters, or word pieces, in one language, the output generated by the neural network may be a translation of the sequence of text into another language, i.e., a sequence of text in the other language that is a translation of the input sequence of text. As a particular example, the task may be a multi-lingual machine translation task, where a single neural network is configured to translate between multiple different source language-target language pairs. In this example, the source language text may be augmented with an identifier that indicates the target language into which the neural network should translate the source language text.

As another example, the task may be an audio processing task. For example, if the input to the neural network is a sequence representing a spoken utterance, the output generated by the neural network may be a score for each of a set of pieces of text, each score representing an estimated likelihood that the piece of text is the correct transcript for the utterance. As another example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram, a waveform, or other data defining audio of the text being spoken in the natural language.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. In this example, both the input sequence of text and the output sequence of text can include tokens from a vocabulary of text tokens that includes, e.g., one or more of characters, sub-words, words, punctuation marks, numbers, or other symbols that appear in a natural language or a computer language.

As a similar example, the task can be an automatic code generation task, where the input is a sequence of words, wordpieces or characters in a first natural language and the output is a sequence of tokens that represent instructions in a computer programming or markup language, or instructions for controlling an application program to perform a task, e.g., build a data item such as an image or web page.

As a particular example of this, the input can represent a context input that includes a text description of a desired piece of code or a snippet of computer code in a programming language and the output can be an output sequence that includes computer code, e.g., a snippet of code that is described by the context input or a snippet of code that follows the context input in a computer program.

As another example, the input to the text generation task can be an input other than text, e.g., an image or audio, and the output sequence can be text that describes the input. In this example, both the input sequence of text and the output sequence of text can include tokens from a vocabulary of tokens that includes tokens that can represent data other than text, in addition to the text tokens mentioned above.

For example, the vocabulary of tokens can additionally include image tokens that represent a discrete set of image patch embeddings of an image that can be generated by an image encoder neural network based on processing the image patches of the image. As another example, the vocabulary of tokens can additionally include audio tokens that represent code vectors in a codebook of a quantizer, e.g., a residual vector quantizer.

As another example, the task can be an image generation task, where the input is a conditioning input, e.g., text, a lower-resolution image, or a partial image, and the output is a sequence of intensity value inputs for the pixels of an image.

As another example, the task can be an image processing task. For example, the input can be the intensity values of the pixels of the image or an encoded representation of the intensity values of the pixels generated by an encoder neural network, and the network output can be (i) an image classification output that classifies the input image into one of a plurality of object categories (ii) an object detection output, i.e., a sequence that specifies the coordinates of one or more bounding boxes in the image that are predicted to encompass objects or (iii) a segmentation output that classifies each pixel in the input image into one of a plurality of categories. As another example, the input can include the intensity values of the pixels of the image or an encoded representation of the intensity values of the pixels generated by an encoder neural network and optionally text, and the network output can be text that characterizes the image, e.g., captions the image or answers a question posed by the text in the input about the image.

As another example, the task can be an audio generation task, where the input is a conditioning input, e.g., text, an image, or context audio, and the output is a sequence of tokens that represents audio.

As another example, the task can be an audio processing task. For example, the input can include audio or an encoded representation of the audio generated by an encoder neural network, and the network output can be text or an image that characterizes the audio.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the neural network is configured to perform multiple different individual machine learning tasks, e.g., two or more of the machine learning tasks mentioned above. For example, the neural network can be configured to perform multiple individual natural language understanding tasks, with the network input including an identifier for the individual natural language understanding task to be performed on the network input.

In some cases, the machine learning task is a multi-modal processing task that requires processing multi-modal data. In general, multi-modal data is a combination of two or more different types of data, e.g., two or more of audio data, image data, text data, or graph data. As one example the multi-modal data may comprise audio-visual data, comprising a combination of pixels of an image or of video and audio data representing values of a digitized audio waveform. As another example the multi-modal data may comprise a combination of i) text data representing text in a natural language and ii) pixels of an image or of video or audio data representing values of an audio waveform. Optionally, but not necessarily, the different types of data may represent the same or overlapping objects using the different modalities (types), and when processing multi-modal data the data may be mapped into a common embedding space.

As a particular example, the task is a multi-modal processing task that requires processing both text and image inputs, so that the neural network includes both a computer vision neural network and a text processing neural network. That is, the target output to be generated by the computer vision neural network for a given image depends on one or more outputs generated by the text processing neural network for one or more corresponding text inputs (and vice versa). Examples of such tasks include open-vocabulary image classification, open-vocabulary object detection, image captioning, text-based image search, image-based retrieval, and so on.

More generally, the multi-modal processing task may correspond to any of the tasks previously described for any of the types of data making up the multi-modal combination. For example, an accuracy of the previously described tasks may be increased when the task is applied to multi-modal data combining the data for which the task has been previously described and another type of data. For example detection or classification of an object or event may be improved when data of multiple different types (modalities) is processed. As another example, the quality (e.g., accuracy, fidelity, or intelligibility) of a generated image, video, or audio may be improved when data of multiple different types (modalities) is processed.

In some cases, once trained, the neural network can perform tasks that it was not explicitly trained to perform. For example the neural network can perform translation tasks (provided that the training corpus included words in different languages), generative tasks, and many other tasks.

In these cases, the neural network can be made to perform a particular task by providing a natural language description of the desired response as a part of the input or “prompt”. The prompt may be a few-shot prompt where a few, e.g., 1 to 10, examples of a query and an example output are provided in the text prior to the actual query.

Additional description of generative tasks that the neural network (when configured as a “generative” neural network) can perform are discussed below.

Generally, the generative neural network is configured to process a conditioning input (“prompt”) to generate a data item. Generally, the data item represents a response to the conditioning input which may be, e.g., a “prompt” for the generative neural network. For example, the conditioning input can characterize one or more desired properties for the generated data item.

In some implementations the generative neural network generates an output token sequence from an input token sequence including the conditioning input. The generative neural network may then be configured to process the input token sequence to generate for each position in the output token sequence, a respective score for each token in a vocabulary of output tokens, that is used to select an output token for the output token sequence.

In some implementations the tokens can represent text, e.g., words, wordpieces or characters, in a natural or computer language. For example, text may be received, e.g., as a series of encoded characters, e.g., UTF-8 encoded characters; such “characters” can include Chinese and other similar characters, as well as logograms, syllabograms and the like. A text encoder, i.e., a tokenizer, can process a sequence of text to represent the text as a series of text tokens from a vocabulary of text tokens, e.g., that each represent words, wordpieces or characters in a natural or computer language. The computer language may be any formal language used to communicate with a computer, e.g., a markup language, or a command or configuration language, or a data exchange language such as JSON, or a programming language. The tokenizer can, e.g., implement BPE (Byte Pair Encoding) or Wordpiece tokenization. Optionally the text can be obtained from audio data representing speech; the output tokens may be converted into audio data that represent speech corresponding to the text.

Also, or instead the tokens may represent an image. For example, a set (sequence) of input or output tokens can represent an image. Each image token may comprise a block encoding of values of the pixels in a different region of an image that maps a set of values of the pixels to a respective image token. The block encoder may comprise a neural network, e.g., having one or more (self-) attention layers, such as a Transformer neural network.

Also, or instead the tokens may represent an audio waveform. For example, a set (sequence) of input or output tokens can represent audio data representing a waveform, e.g., instantaneous audio amplitude values or time-frequency audio data. Each image token may comprise a block encoding of the audio waveform in a different time segment of the audio that maps a set of values representing the audio waveform to a respective image token. The block encoder may comprise a neural network, e.g., having one or more (self-) attention layers, such as a Transformer neural network.

In a multimodal system audio data or an image may be flagged by a start-of-audio token or start-of-image token.

In some implementations the generative neural network can be a multimodal network that is configured to process a conditioning input comprising one or more of text data, audio data defining an audio signal (e.g., as amplitude values of the audio signal or as a time-frequency representation of the audio signal), or a still or moving image (e.g., as image pixel values), to generate a data item that can similarly comprise text data, audio data, or a still or moving image.

For example, the conditioning input may comprise text and the data item may comprise an image or an audio signal that represents speech an image generated in response to the text, e.g., described by the text. Also, or instead the conditioning input may comprise an audio signal that represents speech, or an image, and the data item may comprise text, e.g., that describes the conditioning input.

As another example the conditioning input may comprise an observation, e.g., of a real world environment, e.g., from sensor such as a camera or other image sensor; and optionally additional information such as information defining a particular task to be deformed. The output data item may comprise agent control data that defines one or more actions to be performed by an agent, e.g., by a mechanical agent such as a robot or autonomous vehicle, to perform a task. The reward model(s) may, e.g., define a preferred trajectory of motion of the mechanical agent in the (real-world) environment.

In some implementations the generative neural network may comprise a language and/or image generation neural network, that may have been trained before being fine-tuned by the above described method. The conditioning input may comprise a prompt, e.g., a natural or computer language prompt for the generative neural network. The generated data item may comprise a natural or computer language and/or image response to the prompt.

In general, the neural network can have any appropriate architecture to enable it to perform these machine learning tasks, e.g., to perform a generative task by processing the conditioning input to generate the data item.

In some situations, the neural network can be referred to as an auto-regressive neural network when the neural network auto-regressively generates an output sequence of tokens as the network output. More specifically, the auto-regressively generated output is created by generating each particular token in the output sequence conditioned on a current input sequence that includes an input sequence included in the network input and any tokens that precede the particular token in the output sequence, i.e., the tokens that have already been generated for any previous positions in the output sequence that precede the particular position of the particular token.

As a particular example, the neural network can have any of a variety of Transformer-based neural network architectures, e.g., encoder-only Transformer architectures, encoder-decoder Transformer architectures, decoder-only Transformer architectures, diffusion Transformer architectures, other attention-based architectures, and so on.

Examples of such Transformer-based neural network architectures include those described in Colin Raffel, et al., Exploring the limits of transfer learning with a unified text-to-text transformer. arXiv preprint arXiv: 1910.10683, 2019; Daniel Adiwardana, et al., Towards a human-like open-domain chatbot. CoRR, abs/2001.09977, 2020; Aakanksha Chowdhery, et al., PaLM: Scaling Language Modeling with Pathways, arXiv preprint arXiv: 2204.02311; Rohan Anil, et al., Palm 2 technical report. arXiv preprint arXiv: 2305.10403, 2023; Gemini Team, et al., Gemini: a family of highly capable multimodal models. arXiv preprint arXiv: 2312.11805 (2023); Gemini Team, et al., Gemini 1.5: Unlocking multimodal understanding across millions of tokens of context. arXiv preprint arXiv: 2403.05530 (2024); and Gemma Team, et al., Gemma: Open Models Based on Gemini Research and Technology, arXiv preprint arXiv: 2403.08295 (2024).

For example, the neural network may be a (generative) language mode neural network. Examples of generative language model neural networks include Sparrow (Glaese, et al., arXiv: 2209.14375), Chinchilla (Hoffmann, et al., arXiv: 2203.15556), and PaLM 2 (Anil, et al., arXiv: 2305:10403).

As another example, the neural network may be a multi-modal model neural network, e.g., a vision language model (VLM) neural network. Examples of multi-modal neural networks include Flamingo (Alayrac, et al., arXiv: 2204.14198), PaLI (Chen, et al., arXiv: 2209.06794), and PaLI-X (Chen, et al., arXiv: 2305.18565).

As another example, the neural network may be a foundation model neural network. A foundation model neural network is a large-scale machine learning model trained on a broad data set that can be adapted and fine-tuned for a wide variety of applications and downstream tasks. Examples of foundation model neural networks include Imagen (Saharia, et al., arXiv: 2205.11487) and Parti (Yu, et al., arXiv: 2206.10789).

Based on this set of ambiguous facets 106, the disambiguation system 104 can generate data representing a hierarchical tree 108.

The hierarchical tree 108 includes a respective set of one or more nodes at each of multiple tree levels. Each tree level other than the root level of the tree corresponds to a respective one of the ambiguous facets 106 and each node at the tree level represents a candidate value for the corresponding ambiguous facet given that the ambiguous facets corresponding to any tree levels above the tree level have the candidate values represented by parent nodes of the node. Parent nodes of a given node in a given tree level are nodes in preceding tree levels that link the given node to a node at the root level of the tree.

More specifically, the hierarchical tree 108 has the user input query as a root node, i.e., the node at the root level of the tree. Each level below the root level in the hierarchical tree 108 corresponds to an ambiguous facet in the set of ambiguous facets. The disambiguation system 104 populates the tree level corresponding to an ambiguous facet with a respective set of nodes. Each node represents a candidate value for the ambiguous facet given that the ambiguous facets corresponding to any tree level above the tree level have candidate values represented by parent nodes of the node.

To determine the candidate values for the ambiguous facet corresponding to the tree level that the disambiguation system 104 is populating, the disambiguation system 104 can use a generative neural network to generate child nodes for each node in the preceding tree level (i.e., the generated candidate values for child nodes of a node in the preceding tree level are conditioned on the query represented by the path between the node in the preceding level and a root level node).

Using the generated hierarchical tree 108, the disambiguation system 104 can identify a disambiguated input query 114 by generating a path from the root node in the hierarchical tree 108 to a leaf node of the tree 108. A leaf node is a node that is not a parent node, i.e., that has no child nodes. The path therefore includes a respective node at at least a subset of the plurality of tree levels. A path is thus a series of nodes including one node at each tree level from a root level to a leaf level of the hierarchical tree, where each node specifies a candidate value for the ambiguous facet corresponding to each of at least a plurality of tree levels, thereby identifying a disambiguated input query 114.

The disambiguated input query 114 specifies the respective candidate values represented by the nodes included in the path. That is, the disambiguated input query 114 is a version of the input query 102 that, for each level of the tree that is traversed by the path, specifies the candidate value represented by the node at the level in the tree for the ambiguous facet corresponding to the level.

To generate this path, the disambiguation system 104 can, for each of the at least a subset of the plurality of tree levels, present, to a user, data specifying candidate values 110 of the ambiguous facet corresponding to the tree level. Specifically, data specifying candidate values of the ambiguous facet corresponding to the tree level are represented by child nodes of a node in the path at a preceding tree level.

In response, the disambiguation system 104 receives a user input 112 specifying the value of the ambiguous facet corresponding to the tree level.

The disambiguation system 104 then adds to the path a node representing the value specified by the user input 112.

Once the disambiguation system 104 has reached a leaf node of the hierarchical tree, the disambiguation system can identify a disambiguated input query 114 based on the path generated given the user inputs specifying the value for each ambiguous facet corresponding to each tree level below the root level that takes the user input query as the root node.

Given the disambiguated input query 114, the answer generation system 116 can generate a response to the disambiguated input query 114.

The answer generation system can then provide the response for presentation to the user through the dialog system 100.

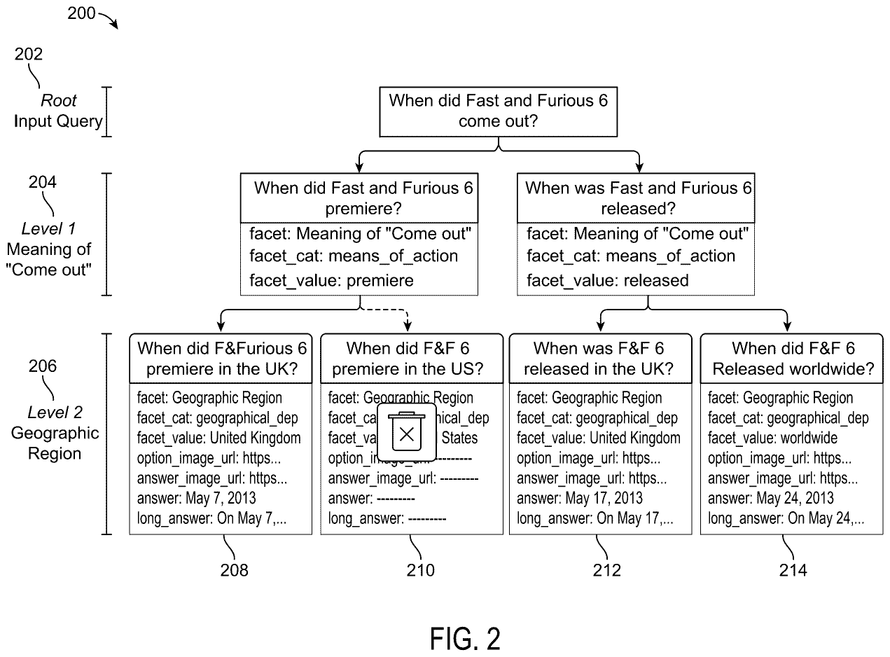

FIG. 2 shows an example hierarchical tree 200. To generate this hierarchical tree 200, an ambiguous facet generation system first generates a set of ambiguous facets given the user input query 102 received from a user through a dialog system. For example, in FIG. 2, given the user input query “When did Fast and Furious 6 come out?” the ambiguous facet generation system generates a set of ambiguous facets that contains the ambiguous facets: (1) meaning of “come out,” and (2) geographic region.

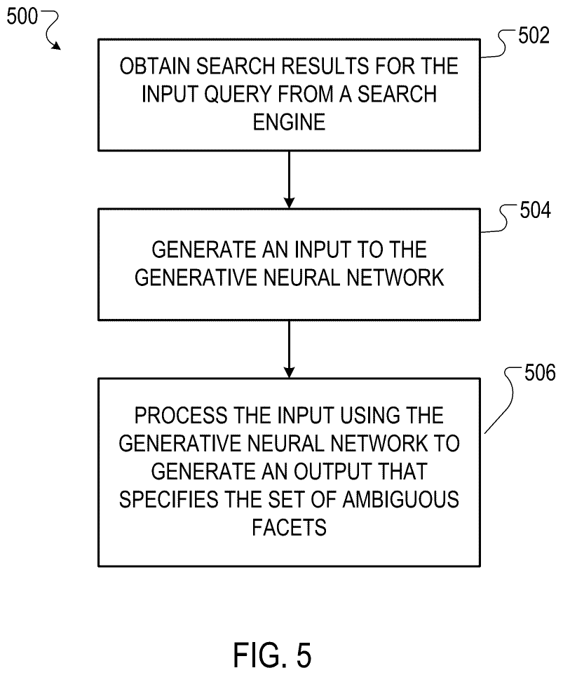

Based on the set of ambiguous facets generated, the disambiguation system can generate a hierarchical tree. To generate a hierarchical tree, the disambiguation system takes the user input query as the root node. The disambiguation system can determine which facet should correspond to which level in any of a variety of ways. For example, the system can determine this from the order of the facets in the set of ambiguous facets. The ordering of the facets and determining the hierarchy of the facets within the hierarchical tree will be described in more detail with reference to FIG. 5 below.

Each level below the root level corresponds to an ambiguous facet and contains nodes that each represent a candidate value for the ambiguous facet. For example, in the hierarchical tree of FIG. 2, the level 204 corresponds to the ambiguous facet of the meaning of “come out.” Level 204 contains two nodes, which represent two candidate values for the meaning of “come out”: “premier” and “release.” For each of these candidate facet values, the disambiguation system can rewrite the root query “When did Fast and Furious 6 come out?” to “When did Fast and Furious 6 premier?” and “When did Fast and Furious 6 release?”

Level 206 corresponds to the ambiguous facet of geographic region. Notably, the candidate values at the level 206 depend on the value that the ambiguous facet corresponding to each preceding level above this level 206 took. Given there is only one parent node representing the meaning of “come out” between the root node and the child nodes of level 206, the child node 208 representing the candidate value of “the UK” and the child node 210 representing candidate value of “the US” depend on their parent node taking the value “premier” for the meaning of “come out.” The child node 212 representing the candidate value of “the UK” and the child node 214 representing the candidate value of “worldwide” depend on their parent node taking the value of “release” for the meaning of “come out.”

Once the disambiguation system has populated each level corresponding to an ambiguous facet with tree nodes representing candidate values for the ambiguous facet, each leaf node of the hierarchical tree corresponds to a respective candidate disambiguated input query.

For each leaf node, an answer generation system can generate a response to the respective candidate disambiguated input query. This can be done 1) when the hierarchical tree is being generated (i.e., in advance) and then stored along with the data representing the hierarchical tree, or 2) dynamically once the path for the disambiguated input query has been generated. In generating a response to the disambiguated input query, the answer generation system can optionally generate a plurality of responses to the disambiguated input query that each provide a different amount of information relating to the disambiguated input query, such as a short concise answer, a long answer with a few paragraphs, and an image. The answer generation system can further store the generated response in association with the leaf node, so that the answer generation system can later retrieve the stored response when generating a response for an identified disambiguated input query. For example, in FIG. 2, the disambiguation system generates a response for each of the leaf nodes 208, 210, 212, and 214, storing in association with each leaf node data of the generated response, including a short concise answer, a long answer with a few paragraphs, and an image. The answer generation system can generate a response to a disambiguated input query using a generative neural network. In addition to providing a prompt to the generative neural network for generating a response to the disambiguated input query, the answer generation system can further ground the generation process for accuracy by supplying the generative neural network search results (e.g., a top number of web pages) that a search engine (e.g., an Internet search engine) retrieves from performing a search with the disambiguated input query that the answer generation system submits to it.

It may be possible that the answer generation system determines that a particular leaf node corresponds to an invalid candidate disambiguated input query. A candidate disambiguated input query is invalid when it is unanswerable (i.e., a candidate value of an ambiguous facet in the path is incorrectly generated). For example, in FIG. 2, the candidate facet value “United States” is an incorrect value for the parent query “When did Fast and Furious 6 premier?” as the movie only premiered in the UK. Thus, after using the generative neural network to generate a response to the leaf node that corresponds to the disambiguated input query “When did F&F 6 premiere in the US?” and receiving no answer or receiving a response that indicates that there is no correct answer to the query, the answer generation system determines that “When did F&F 6 premiere in the US?” is an invalid candidate disambiguated input query. In response to detecting such a leaf node, the answer generation system can iteratively prune the tree until the particular leaf node and all parent nodes of the particular leaf node that do not have other child nodes are removed from the tree. For example, in FIG. 2, the answer generation system prunes the leaf node 210 representing the invalid candidate disambiguated input query “When did Fast & Furious 6 premiere in the US?” Since the parent node of the leaf node 210 has another child node 208, the answer generation system stops iteratively pruning the hierarchical tree.

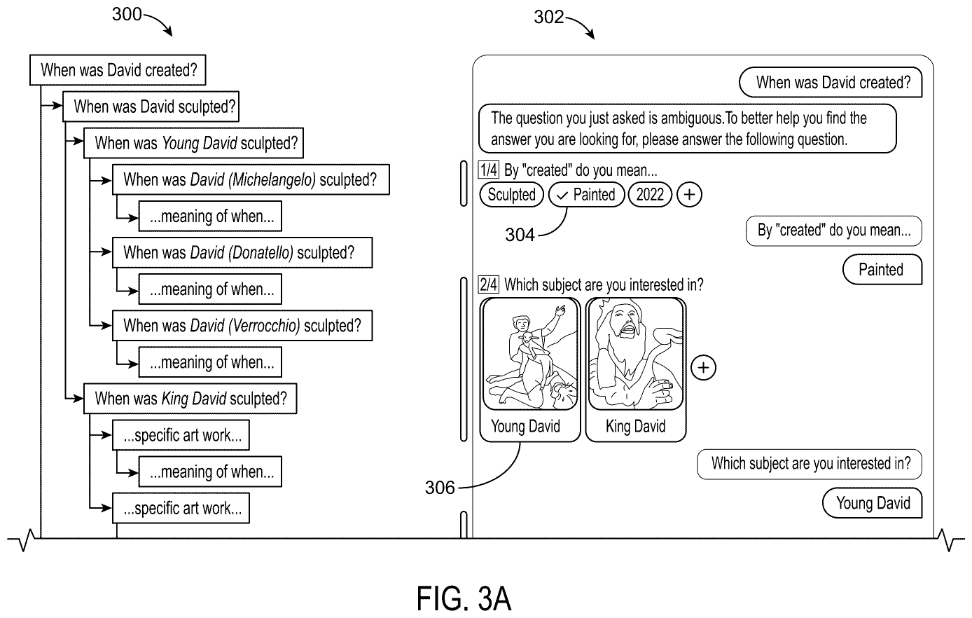

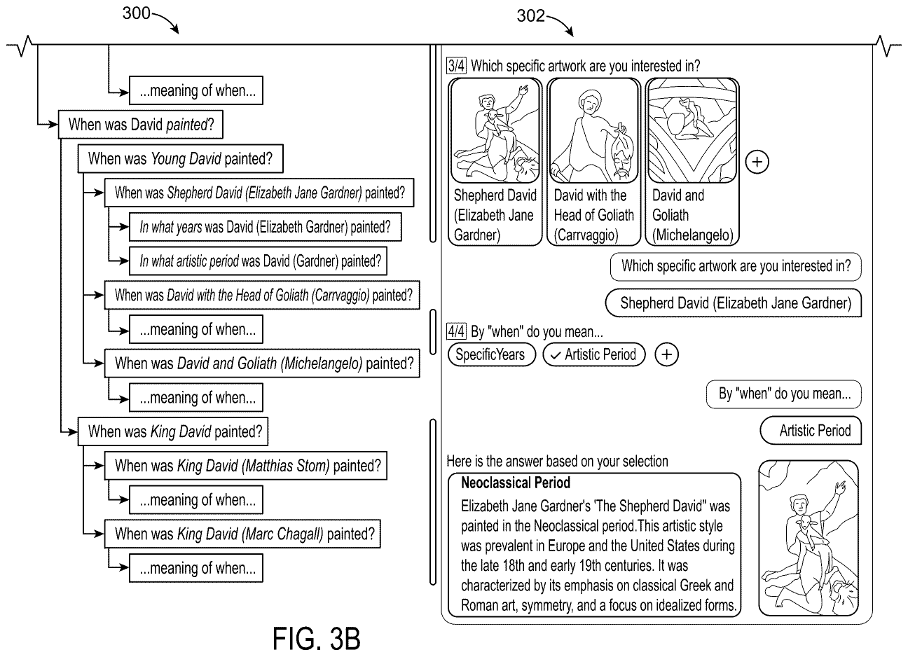

FIGS. 3A and 3B show an example graphical user interface for the disambiguation process and the corresponding hierarchical tree generated.

Through the dialog system illustrated by the example graphical interface 302 on the right of FIGS. 3A and 3B, the user inputs an input query. For example, in FIG. 3A, the user inputs an input query “when was David created?” The example graphical interface 302 on FIG. 3B is a continuation of the example graphical interface 302 on FIG. 3A.

From this received input query, an ambiguous facet generation system generates a set of ambiguous facets from the input query using a generative neural network. For example, in FIGS. 3A and 3B, the set of ambiguous facets generated are the meaning of “created,” the life stage of David, specific artwork, and the meaning of “when.” While this is one reasonable breakdown of the query, the ambiguous facet generation system can generate other ambiguous facets to organize the information space of the input query, such as by artist, material (e.g., oil painting, marble, or bronze), and by the nature of patronage (i.e., how the artwork was commissioned).

Based on the set of ambiguous facets generated by the ambiguous facet generation system, the disambiguation system generates a hierarchical tree 300. The hierarchical tree 300 on FIG. 3B is a continuation of the hierarchical tree 300 on FIG. 3A. The hierarchical tree 300 takes the input query, “when was David created?” in the example of FIGS. 3A and 3B, as the root node. Below the root node, each tree level corresponds to an ambiguous facet, organized in the order of the meaning of “created,” the life stage of David, specific artwork, and the meaning of “when” in the hierarchical tree 300 of FIGS. 3A and 3B.

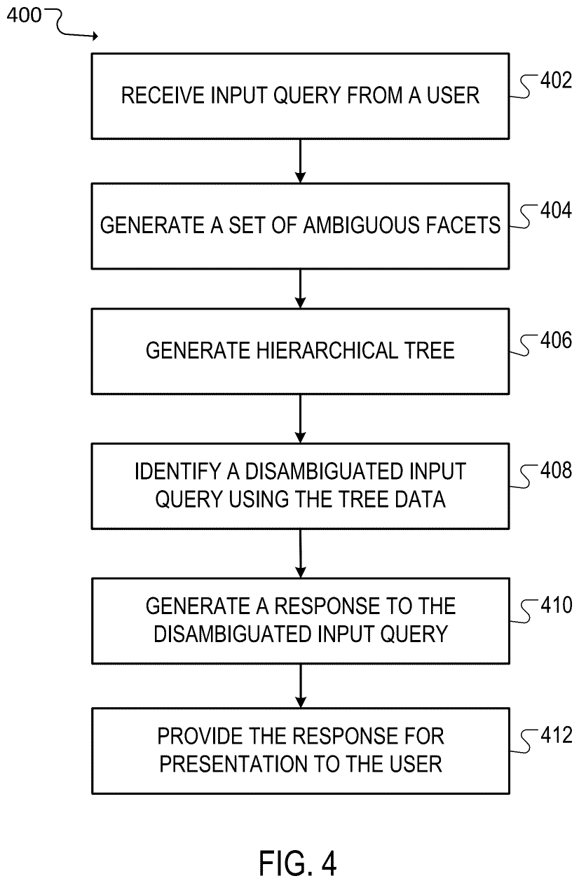

The disambiguation system populates each tree level corresponding to an ambiguous facet with a respective set of nodes with each node representing a candidate value for the ambiguous facet given that the ambiguous facets corresponding to any tree level above the tree level have candidate values represented by parent nodes of the node. Generating candidate values for an ambiguous facet is described in more detail below with reference to FIG. 4. For example, on the left of FIGS. 3A and 3B show a hierarchical tree 300 populated with the nodes “sculpted” and “painted” for the tree level corresponding to the ambiguous facet of the meaning of “created.” For the next tree level below corresponding to the ambiguous facet of the life stage of David, the disambiguation system populates the level with nodes representing candidate facet values “Young David” and “King David” as child nodes for respective parent nodes representing the values “sculpted” and “painted.” For the next tree level below corresponding to the ambiguous facet of specific artwork, given the parent nodes take the value of “Young David” for the life stage of David and the value of “painted” for the meaning of “created,” the disambiguation system populates the level with nodes representing the candidate facet values “Shepherd David (Elizabeth Jane Gardner),” “David with the Head of Goliath (Caravaggio),” and “David and Goliath (Michelangelo).” However, for example, given parent nodes taking the value of “Young David” for the life stage of David and the value of “sculpted” for the meaning of “created,” the disambiguation system populates the level corresponding to specific artwork with nodes representing candidate values “David (Michelangelo),” “David (Donatello),” and “David (Verrocchio).” Given parent nodes taking the value of “King David” for the life stage of David and the value of “painted” for the meaning of “created,” the disambiguation system populates the level corresponding to specific artwork with nodes representing candidate values “King David (Matthias Stom)” and “King David (Marc Chagall).”

Using the generated hierarchical tree 300, the disambiguation system can indicate to the user the number of clarifying questions the system needs to ask to disambiguate the input query. Each clarifying question asks for user input to specify the value for an ambiguous facet. The disambiguation system can present to the user data specifying the candidate values of the ambiguous facet. Using an ambiguous facet types taxonomy, the disambiguation system can decide, depending on the facet type of the ambiguous facet, to present to the user a suggestive option in plain-text 304 or a suggestive option containing text with visual aids 306. An ambiguous facet types taxonomy is data identifying, in a top-to-bottom sequence, the types of ambiguous facets. The ambiguous facet types taxonomy can further include data identifying the definition and example for each type of ambiguous facet.

The disambiguation system identifies a disambiguated input query by generating a path from a root node to a leaf node of the hierarchical tree 300.

Given user input to each clarifying question, the disambiguation system can traverse the hierarchical tree 300 to generate a path from a root node to a leaf node, identifying a disambiguated input query. For example, in FIGS. 3A and 3B, the disambiguation system can add to the path a node specifying the value inputted by the user in response to each clarifying question, leading to the disambiguated input query “In what artistic period was David (Gardner) painted?”

Given the disambiguated input query, the answer generation system can generate an answer to present to the user. Alternatively, the answer generation system can retrieve a response that has been generated and stored in association with the leaf node corresponding to the disambiguated input query.

FIG. 4 is a flow diagram of an example process 400 for generating a response to an input query. For convenience, the process 400 will be described as being performed by a system of one or more computers located in one or more locations. For example, a system, e.g., the dialog system 100 of FIG. 1, appropriately programmed in accordance with this specification, can perform the process 400.

The system first receives an input query from a user (step 402).

The system can then generate a set of ambiguous facets of the input query using a generative neural network (step 404). To generate the set of ambiguous facets, the system can generate input to the generative neural network from search results for the input query from a search engine. The system can further use data specifying a taxonomy of ambiguous facet types in generating input to the generative neural network. Generating input for the generative neural network to generate a set of ambiguous facets is described in more detail below with reference to FIG. 5.

In addition to generating a set of ambiguous facets, the generative neural network can further identify, for each ambiguous facet, an ambiguous facet type for the ambiguous facet. To do so, input to the generative neural network can further include data specifying a taxonomy of ambiguous facet types. The generative neural network can then use this data to, for instance in the example of FIG. 2, identify that the ambiguous facet of the meaning of “come out” is of a means of an action ambiguous facet type, and the ambiguous facet of geographic region is of a geographical dependency ambiguous facet type.

The system can generate tree data representing a hierarchical tree (step 406). The system determines which facet should correspond to which level by the order of the facets in the set of ambiguous facets. The ordering of the facets and determining the hierarchy of the facets within the hierarchical tree will be described in more detail with reference to FIG. 5 below. The system populates each tree level corresponding to an ambiguous facet with nodes. Each node represents a candidate value for the corresponding ambiguous facet given that the ambiguous facets corresponding to any tree levels above the tree level have the candidate values represented by parent nodes of the node. In some implementations, after generating candidate values for child nodes of a particular parent node, the system can instruct a generative neural network to generate a rewrite of the input query given a candidate value for a child node and the respective candidate values represented by parent nodes of the child node, and then add a new child node with the respective candidate value and the query rewrite to the particular parent node.

The system can generate candidate values for the ambiguous facet corresponding to the tree level using a generative neural network. The system can generate an input to the generative neural network from the input query and respective candidate values of ambiguous facets represented by the node in the preceding tree level and any parent nodes of the node in the preceding tree level. The generative neural network can process an input to generate an output specifying candidate values for the ambiguous facet corresponding to the tree level given that the ambiguous facets corresponding the preceding tree level and any parent nodes of the node in the preceding tree level have the candidate values represented by the node in the preceding tree level and any parent nodes of the node.

For instance, in the example of FIG. 3, given the input query “When was David created?”, the candidate value “sculpted” for the ambiguous facet of the meaning of “created,” the candidate value “Young David” for the ambiguous facet of the life stage of David, the system can generate an input to the generative neural network to generate candidate values for child nodes of the node having the candidate value “Young David.” In some implementations, for example, the input that the system generates for the generative neural network can be the query “When was Young David sculpted?” which the system has, in some implementations, furthermore stored in the node that the system is populating child nodes for. Given the input the system generates from the input query “When was David created?”, the candidate value “sculpted” for the ambiguous facet of the meaning of “created,” the candidate value “Young David” for the ambiguous facet of the life stage of David, the generative neural network can output candidate values “David (Michelangelo),” “David (Donatello),” and “David (Verrocchio)” to populate the tree level corresponding to the ambiguous facet of specific artwork with child nodes of the node having the candidate value of “Young David.” In this example, the candidate values “David (Michelangelo),” “David (Donatello),” and “David (Verrocchio)” that the generative neural network outputs are conditioned on the ambiguous facet of the life stage of David corresponding to the preceding tree level taking the candidate value “Young David,” the ambiguous facet of the meaning of “created” taking the candidate value “sculpted,” and the root node having the input query of “When was David created?”

Optionally, for each leaf node of the hierarchical tree that corresponds to a respective candidate disambiguated input query, the system can further generate a response and store the response in association with the leaf node.

The system can identify a disambiguated input query using the tree data (step 408).

To identify a disambiguated input query using the tree data, the system can generate a path from a root node to a leaf node of the tree data representing the hierarchical tree. For each of at least a subset of the plurality of tree levels, the path includes a node representing the value specified by the user for the ambiguous facet corresponding to the respective tree level.

The system can present to the user candidate values of the ambiguous facet corresponding to the tree level. These candidate values provided by the system to the user are represented by child nodes of a node in the path at a preceding tree level. For instance, in the example of FIG. 3, at the next tree level below a root node representing the input inquiry “When was David created?”, the system can present to the user “sculpted” and “painted,” which are candidate values of the ambiguous facet of the meaning of “created” and child nodes to the root node.

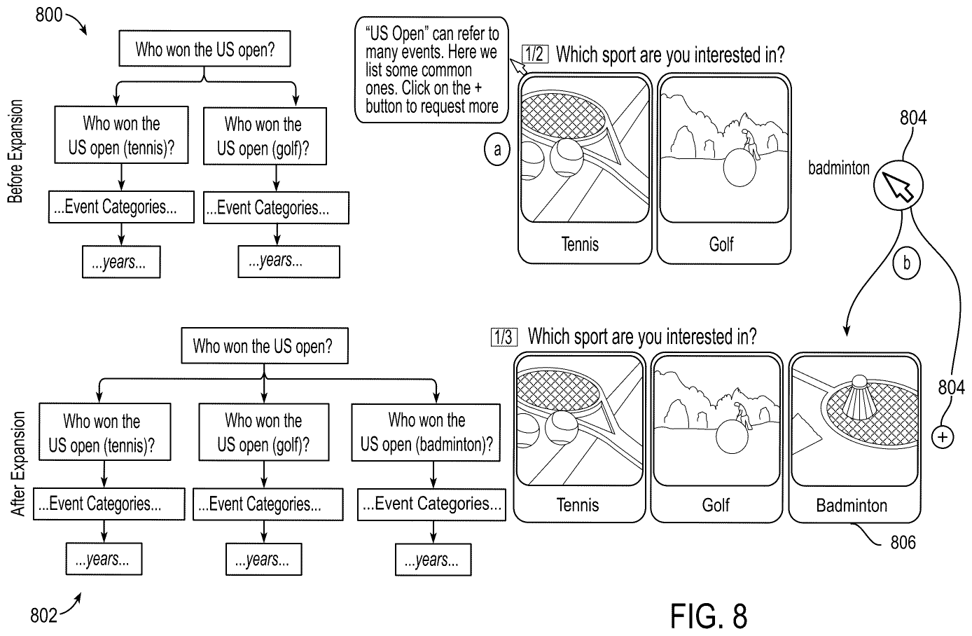

In response, the method can receive user input specifying a value of the ambiguous facet corresponding to the tree level. The user can provide user input by selecting one of the candidate values of the ambiguous facet corresponding to the tree level. Alternatively, the user can choose to specify a new value for the ambiguous facet, whereupon the system updates the tree data of the hierarchical tree to include data representing the new node at the tree level that represents the new value for the ambiguous facet. In doing so, the system can further update the tree data to include one or more child nodes of the new node. Receiving a user input specifying a new value for the ambiguous facet and expanding the hierarchical tree is described in more detail below with reference to FIG. 8.

The system can add to the path the node representing the value specified by user input.

The system can generate a response to the disambiguated input query (step 410).

The response to the disambiguated input query can be generated once the disambiguate input query has been identified. Alternatively, the response to the disambiguated input query can be retrieved from the tree data had the tree data store a generated response in association with the leaf node corresponding to the disambiguated input query.

The system can provide the response for presentation to the user (step 412).

FIG. 5 is a flow diagram of an example process 500 for generating a set of ambiguous facets of an input query. For convenience, the process 500 will be described as being performed by a system of one or more computers located in one or more locations. For example, a system, e.g., the dialog system 100 of FIG. 1 and the ambiguous facet generation system 600 of FIG. 6 described in more detail below, appropriately programmed in accordance with this specification, can perform the process 500.

The system first obtains search results for the input query from a search engine (step 502). To do so, the system submits the input query to a search engine, e.g., an Internet search engine, and obtains search results, e.g., a top number of web pages retrieved by the search engine via a search of the input query. The input query that the system submits to the search engine is the user inputted query, which can be ambiguous.

By performing an online search and obtaining search results for the input query from a search engine, the system can supply a generative neural network with grounded data, allowing Retrieval Augmented Generation (RAG). The system can further supply a generative neural network with an ambiguity facet types taxonomy. Through the supply of such data to the generative neural network, the system can alleviate hallucination of a generative neural network for more accurate and factually correct results.

An ambiguous facet types taxonomy includes data identifying, in a top-to-bottom sequence, the types of ambiguous facets. The ambiguous facet types taxonomy can further include data identifying a definition and example for each facet type. From an ambiguous factual question dataset where each data entry consists of an original question and pairs of disambiguated questions and answers, a generative neural network can summarize the dataset to generate the ambiguity facet types taxonomy. To do so, the generative neural network extracts a list of facets for each data entry, and at the same time, uses a sentence embedding model, e.g., a self-attention embedding neural network, e.g., a BERT-based sentence embedding model, a Universal Sentence Embedding model, and so on, a recurrent neural network sentence embedding model, e.g., a uni-directional or a bi-directional long short-term memory (LSTM) sentence embedding model, or a sentence embedding model that includes both recurrent and self-attention layers, to cluster the data entries into clusters based on the similarities between the original questions of each data entry. The generative neural network can then summarize the extracted facets of data queries in the same cluster into higher-level facet categories and can further refine the summarized facet categories of each cluster by identifying similar ones. A training database comprising original question and pairs of disambiguated questions and answers can straightforwardly be generated, e.g., from human users.

The system then generates an input to the generative neural network (step 504).

The input to the generative neural network includes a prompt for the generative neural network to generate a set of ambiguous facets, as well as contents from the search results and the input query. The input can further include data specifying the taxonomy of ambiguous facet types. For example, the prompt for the generative neural network can be as follows:

‘‘‘
A facet of a query is an aspect of that query.
Types of Ambiguities and Examples
1. Ambiguities in Question Nouns
1.1 Entity Reference Ambiguity
“Entity” is a proper noun that refers to a specific thing, such people,
places, events, etc. However, multiple different entities can share the
same name, causing ambiguities.
Examples:
When did the US Open take place?
When did the US Open Tennis Championship take place?
When did the US Open Golf Championship take place?
1.2 Instance/Part of Entity Reference Ambiguity
For a specified entity, there can still be ambiguity in terms of which
specific instance or part of that entity is being referred to
Examples:
When was the smartphone brand released?
When were the particular models of a smartphone brand released?
When were the original models of a smartphone brand released?
Who won the US Open Tennis Championship in 2023?
Who won the US Open Tennis Championship Men's Singles event in
2023?
Who won the US Open Tennis Championship Women's Doubles event in
2023?
..... more examples and definitions ....
Given the contextual information from webpages, identify the facets of
the following query, include a definition for each facet:
{ {user_query} }
Then, label each facet with true if its value is specified in the query, and
false otherwise.
Output format:
{
“facet_name”: <name>,
“facet_definition”: <definition>,
“specified”: <true | false>
}
{ {web_information} }
‘‘‘

The system processes the input using the generative neural network to generate an output that specifies the set of ambiguous facets (step 506). For example, when the generative neural network processes the example prompt given above, the system can identify, as the ambiguous facets, some or all of the facets that are labeled as false in the output of the generative neural network.

Optionally, the generative neural network can further label each ambiguous facet in the generated set with an ambiguous facet type for the ambiguous facet.

It may be possible that the generative neural network can detect no ambiguous facets from the input query. In such cases, the generative neural network can produce an empty set.

The system can then use the generative neural network to order the ambiguous facets in the set, e.g., by processing another input using the generative neural network. The generative neural network can order the ambiguous facets based on the information coverage in the search results and, optionally, the ambiguity facet types taxonomy. To do so, the system can prompt the generative neural network to generate an ordered set of ambiguous facets given the context of the search results and, optionally, the ambiguity facet types taxonomy. For example, the prompt for the generative neural network can be as follows:

‘‘‘
Given the following query:
{ {user_query} }
And the following facets that are not specified in the query:
{ {facets_from_prior_steps} }
Given the contextual information from webpages, rank these facets in
terms of information gain. 1 is the highest.
{ {web_information} }
‘‘‘

In some cases, in addition to supplying search results to guide the generative neural network, the system can guide the generative neural network to follow the top-to-bottom sequence of the facet types listed in the ambiguity facet types taxonomy. Ambiguities in the question stem (e.g., nouns, verbs, and the question adverb) of the input query can be prioritized, whereas ambiguities in question scopes such as missing temporal and geographical information can be prioritized at the end. Furthermore, for example, ambiguous facets of certain categories can be ordered to follow other ambiguous facets of other categories. For instance, in the example of FIG. 2, the system can cause the generative neural network to output an ordered set of ambiguous facets by supplying the ambiguity facet types taxonomy to the generative neural network. The ambiguity facet types taxonomy can have the ambiguous facet type, means of action, ordered in a top-to-bottom sequence above the ambiguous facet type, geographical dependency. Thus, the generative neural network can order ambiguous facets in the category of geographical dependency to follow ambiguous facets in the category of means of action.

FIG. 6 is a block diagram of an example ambiguous facet generation system 600.

The ambiguous facet generation system 600 takes in the input query 102 from a user. The ambiguous facet generation system 600 can feed the input query into a search engine 602 to generate search results 604.

From the contents of the search results 604 and the input query 102, the ambiguous facet generation system 600 generates an input to the generative neural network 608. The generative neural network 608 processes the input to generate an output that specifies the set of ambiguous facets.

The input to the generative neural network 608 can be e.g., entire web pages identified by the top N search results, that a search engine 602, e.g., an Internet search engine, generates by performing a search on the input query 102. In addition to supplying search results 604 for the ambiguous facet generation system 600 to generate an input for the generative neural network 608, the ambiguous facet generation system 600 can further supply an ambiguous facet types taxonomy 606 to the generative neural network 608.

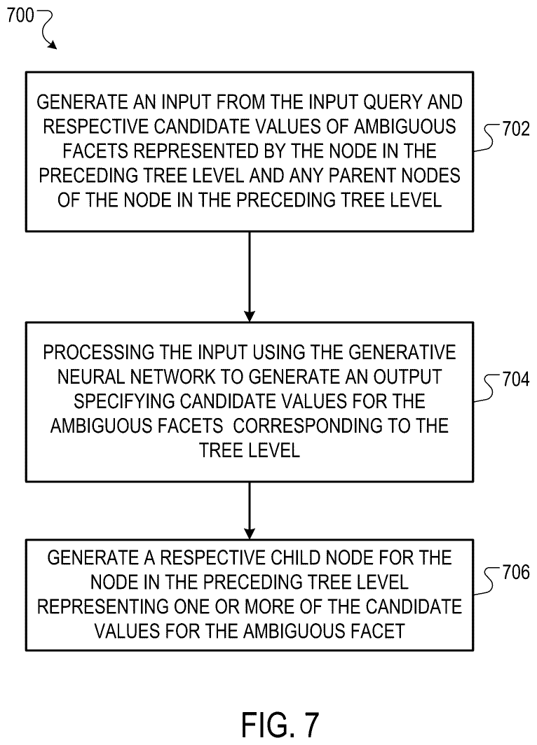

FIG. 7 is a flow diagram of an example process 700 for generating tree data representing a hierarchical tree. For convenience, the process 700 will be described as being performed by a system of one or more computers located in one or more locations. For example, a system, e.g., the dialog system 100 of FIG. 1 and more specifically the disambiguation system 104 of FIG. 1, appropriately programmed in accordance with this specification, can perform the process 700.

The system generates an input from the input query and respective candidate values of ambiguous facets represented by the node in the preceding tree level and any parent nodes of the node in the preceding tree level (step 702). The input to prompt the generative neural network to generate candidate values for a given ambiguous facet is conditioned on the query stored in each node in the level above.

The system processes the input using the generative neural network to generate an output specifying candidate values for the ambiguous facet corresponding to the tree level given that the ambiguous facets corresponding to the preceding tree level and any parent nodes of the node in the preceding tree level have the candidate values represented by the node in the preceding tree level and any parent nodes of the node (step 704). The output that the generative neural network generates can be a set of candidate facet values for a given parent node at a given tree level corresponding to an ambiguous facet. The system can augment the output of candidate values generated by the generative neural network with search results, e.g., top search engine results, obtained from a search engine, e.g., an Internet search engine, by performing a search of the query represented by the path between a root node and the parent node of child nodes that the system is populating using candidate values that the generative neural network generates.

The system generates a respective child node for the node in the preceding tree level representing one or more of the candidate values for the ambiguous facet corresponding to the tree level (step 706). Each candidate value that the generative neural network outputs is therefore represented as a child node for the node in the preceding tree level containing the query that the input to the generative neural network was conditioned on.

For each node representing a candidate value generated by the generative neural network for the ambiguous facet, the generative neural network can rewrite the input query to replace the ambiguous facet with the candidate value represented by the node.

In some implementations, tree data representing the hierarchical tree for all of the tree levels is generated before generating the path representing a disambiguated input query.

In some other implementations, the system can generate the hierarchical tree dynamically while generating the path representing the disambiguated input query. For example, whilst waiting for the user input specifying the value of an ambiguous facet corresponding to a current particular tree level, the tree data representing the hierarchical tree for at least the next particular tree level can be generated. This can be done by processing the input using the generative neural network to generate the output specifying candidate values for the ambiguous facet corresponding to the next particular tree level in parallel with receiving, the user input for the current particular tree level. Optionally, multiple instances of the generative neural network can be run in parallel to generate the candidate values (for the ambiguous facet corresponding to the next particular tree level) in parallel. Optionally the tree data representing the hierarchical tree for all the next tree levels until one of the leaf nodes is reached can be generated. Generating the tree dynamically in this manner can reduce the overall latency between when the user query is received by the system and when the process for disambiguating the user query begins and allow the system to perform lookahead processing to obtain information for resolving future ambiguities.

In some implementations, as previously described, a candidate disambiguated input query is processed using an answer generation system that, in turn, uses a search engine to perform a search using the candidate disambiguated input query to obtain the response. Then whilst waiting for, i.e., in parallel with receiving, the user input specifying the value of the ambiguous facet corresponding to one or more of the particular tree levels the system can i) generate the tree data representing the hierarchical tree for each next particular tree level until reaching one of the leaf nodes, and then ii) perform the search using the respective candidate disambiguated input query corresponding to the leaf node

FIG. 8 shows a hierarchical tree before 800 and after expansion 802 from a user input of an alternative value to the candidate values provided in the example graphical user interface.

From a hierarchical tree populated with candidate values generated by the generative neural network at each tree level corresponding to an ambiguous facet, the disambiguation system identifies a disambiguated input query by asking for user input of each ambiguous facet to determine a path from the root node to a leaf node in the hierarchical tree. To determine the node at a tree level to add to the path for identifying a disambiguated input query, the disambiguation system presents the clarifying question and candidate values corresponding to the tree level to the user. Trailing the list of candidate values that are presented for the user to select is an option 804 for the user to input a specific value not already presented to the user. For example, in FIG. 8, the user has the option to click on the “+” button to input a value that is not available for the user to select.

Upon receiving user input for a value other than the candidate values presented to the user as suggestive options for selection, the disambiguation system can update the hierarchical tree 802 to include a new node representing the value that the user inputted through the option to provide alternative values other than the candidate values presented as suggestive options for the user to select. The disambiguation system can further expand the hierarchical tree 802 after user input of an alternative value other than those presented for the user to select by building a new subtree attached to the new node. The expanded hierarchical tree 802 can thus include one or more child nodes of the new node.

In some implementations the input query comprises a request for diagnosing a fault in a mechanical system, e.g., machine, electronic system, e.g., electronic circuit, or computing system, e.g., a computer program running on one or more computers. The input query can include fault log data that has been captured from the mechanical, electronic, or computing system that characterizes the fault. This can comprise, e.g., a text description, e.g., debug data for a computer program or other low-level system log data, and or one or more still or moving images, e.g., of a part of a machine or a screenshot, and or audio data, e.g., of the sound made by a machine. Such information can, but need not be, captured whilst the system is operating. The set of ambiguous facets of the input query can then relate to any aspects of the fault that can have multiple possible values. The response can identify a cause of the fault. In some implementations the identified cause of the fault can be used, manually or automatically (e.g., by another system), to repair the fault. In general the ability to for a user to interact with the system as described above can facilitate homing in on a particular fault diagnosis.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
receiving an input query;
generating, from the input query and using a generative neural network, a set of ambiguous facets of the input query;
generating tree data representing a hierarchical tree using the set of ambiguous facets of the input query, wherein the hierarchical tree includes a respective set of nodes at each of a plurality of tree levels, wherein each tree level corresponds to a respective one of the ambiguous facets and each node at the tree level represents a candidate value for the corresponding ambiguous facet, wherein generating the tree data comprises:
for each ambiguous facet, populating the tree level corresponding to the ambiguous facet with nodes, each node representing a respective candidate value for the ambiguous facet;
identifying a disambiguated input query using the tree data, comprising generating a path from a root node in the hierarchical tree to a leaf node of the hierarchical tree, wherein the path includes a respective node at at least a subset of the plurality of tree levels, wherein the disambiguated input query specifies the respective candidate values represented by the nodes included in the path, and wherein generating the path comprises, for each of the at least a subset of the plurality of tree levels:
providing, for presentation to a user, data specifying the candidate values for the ambiguous facet corresponding to a current tree level;
in response, receiving data representing a user input specifying a value of the ambiguous facet corresponding to the current tree level; and
adding, to the path, a node representing the specified value;
generating a response to the disambiguated input query; and
providing the response for presentation to the user.

2. The method of claim 1, wherein:
receiving the user input specifying the value of the ambiguous facet corresponding to the tree level comprises receiving the user input selecting one of the candidate values of the ambiguous facet corresponding to the tree level; and
adding, to the path, the node representing the specified value comprises adding the node representing the selected candidate value.

3. The method of claim 1, wherein:
receiving the user input specifying the value of the ambiguous facet corresponding to the tree level comprises receiving the user input specifying a new value for the ambiguous facet;
the method further comprises:
updating the tree data to include data representing a new node at the tree level that represents the new value for the ambiguous facet; and
adding, to the path, the node representing the specified value comprises adding the new node representing the new value.

4. The method of claim 3, wherein updating the tree data to include the data representing the new node at the tree level that represents the new value for the ambiguous facet comprises updating the tree data to include one or more child nodes of the new node.

5. The method of claim 1, wherein generating, from the input query and using the generative neural network, the set of ambiguous facets of the input query comprises:
obtaining search results for the input query from a search engine;
generating an input to the generative neural network that comprises contents from the search results and the input query; and
processing the input using the generative neural network to generate an output that specifies the set of ambiguous facets.

6. The method of claim 5, wherein the input to the generative neural network further comprises data specifying a taxonomy of ambiguous facet types.

7. The method of claim 6, wherein the output of the generative neural network further identifies, for each ambiguous facet, an ambiguous facet type for the ambiguous facet.

8. The method of claim 1, wherein generating the tree data representing the hierarchical tree comprises, for each tree level and for each node in a preceding tree level:
generating an input from the input query and respective candidate values of ambiguous facets represented by the node in the preceding tree level and any parent nodes of the node in the preceding tree level; and
processing the input using the generative neural network to generate an output specifying candidate values for the ambiguous facet corresponding to the tree level given that the ambiguous facets corresponding to the preceding tree level and any parent nodes of the node in the preceding tree level have the candidate values represented by the node in the preceding tree level and any parent nodes of the node; and
generating a respective child node for the node in the preceding tree level representing one or more of the candidate values for the ambiguous facet corresponding to the tree level.

9. The method of claim 8, wherein, for each of one or more particular tree levels of the tree levels, the tree data representing the hierarchical tree for at least a next particular tree level in the hierarchical tree is generated in parallel with identifying the node in the path at the particular tree level.

10. The method of claim 9, wherein, for each next particular tree level, processing the input using the generative neural network to generate an output specifying candidate values for the ambiguous facet corresponding to the next particular tree level is performed in parallel with identifying the node in the path at the particular tree level.

11. The method of claim 1, wherein:
each leaf node of the hierarchical tree corresponds to a respective candidate disambiguated input query;
generating the tree data further comprises, for each leaf node:
generating a response to the respective candidate disambiguated input query corresponding to the leaf node; and
storing the response in association with the leaf node; and
generating the response to the respective input query comprises:
retrieving, from the tree data, the response associated with the leaf node in the path.

12. The method of claim 11, wherein:
generating the response to the respective candidate disambiguated input query corresponding to the leaf node comprises processing the respective candidate disambiguated input query using an answer generation system, the answer generation system using a search engine to perform a search using the respective candidate disambiguated input query to obtain the response; and
wherein the method further comprises:
in parallel with identifying the nodes in the path at one or more of particular tree levels: i) generating the tree data representing the hierarchical tree for each next particular tree level until reaching one of the leaf nodes, and then ii) performing the search using the respective candidate disambiguated input query corresponding to the leaf node.

13. The method of claim 1, wherein generating the tree data further comprises:
determining that a particular leaf node corresponds to an invalid candidate disambiguated input query; and
in response:
iteratively pruning the hierarchical tree until the particular leaf node and all parent nodes of the particular leaf node that do not have other child nodes are removed from the hierarchical tree.

14. The method of claim 1, wherein generating the response to the disambiguated input query comprises:
generating a plurality of responses to the disambiguated input query that each provide a different amount of information relating to the disambiguated input query.

15. The method of claim 1, wherein generating the response to the disambiguated input query further comprises obtaining an image by querying an image search engine.

16. The method of claim 1, further comprising:
after identifying the disambiguated input query using the tree data, receiving a user input identifying a particular node in the hierarchical tree; and
traversing the hierarchical tree starting from the particular node to identify another disambiguated input query.

17. The method of claim 1, wherein:
the input query comprises a request for diagnosing a fault in a mechanical, electronic, or computing system and includes fault log data that has been captured from the mechanical, electronic, or computing system that characterizes the fault;
the set of ambiguous facets of the input query relate to aspects of the fault that can have multiple possible values; and
the response identifies a cause of the fault.

18. The method of claim 17, further comprising using the identified cause of the fault to repair the fault.

19. A method performed by one or more computers, the method comprising:
receiving an input query from a user;
obtaining data specifying a disambiguated input query from the input query, comprising:
for each of at least a subset of a plurality of tree levels that each correspond to a respective one of a set of ambiguous facets of the input query and that each have one or more nodes that represent a candidate value for the corresponding ambiguous facet:
presenting to the user data specifying the candidate values for the ambiguous facet corresponding to the tree level;
in response, obtaining a user input specifying a value of the ambiguous facet corresponding to the tree level; and
indicating, in the disambiguated input query, that the ambiguous facet corresponding to the tree level has the specified value;
obtaining a response to the disambiguated input query; and
providing the response for presentation to the user.

20. A system comprising one or more computers and one or more storage devices storing instructions that when executed by the one or more computers cause the one or more computers to perform operations comprising:
receiving an input query;
generating, from the input query and using a generative neural network, a set of ambiguous facets of the input query;
generating tree data representing a hierarchical tree using the set of ambiguous facets of the input query, wherein the hierarchical tree includes a respective set of nodes at each of a plurality of tree levels, wherein each tree level corresponds to a respective one of the ambiguous facets and each node at the tree level represents a candidate value for the corresponding ambiguous facet, wherein generating the tree data comprises:
for each ambiguous facet, populating the tree level corresponding to the ambiguous facet with nodes, each node representing a respective candidate value for the ambiguous facet;
identifying a disambiguated input query using the tree data, comprising generating a path from a root node in the hierarchical tree to a leaf node of the hierarchical tree, wherein the path includes a respective node at at least a subset of the plurality of tree levels, wherein the disambiguated input query specifies the respective candidate values represented by the nodes included in the path, and wherein generating the path comprises, for each of the at least a subset of the plurality of tree levels:
providing, for presentation to a user, data specifying the candidate values for the ambiguous facet corresponding to a current tree level;
in response, receiving data representing a user input specifying a value of the ambiguous facet corresponding to the current tree level; and
adding, to the path, a node representing the specified value;
generating a response to the disambiguated input query; and
providing the response for presentation to the user.
